(19) United States
(12) Patent Application Publication
(10) Pub. No.: US 2007/0069869 A1
(43) Pub. Date: Mar. 29, 2007

(54) Automobile security and reporting system

(76) Inventor: Vaughn R. Arnold, West Palm Beach, FL (US)

Correspondence Address: MCHALE & SLAVIN, P.A., 2855 PGA BLVD, PALM BEACH GARDENS, FL, 33410, US

(21) Appl. No.: 11/240,166

(22) Filed: Sep. 29, 2005

(51) Int. Cl. B60Q 1/00

(52) U.S. Cl. 340/425.5; 340/825.36; 340/7.59; 340/426.19

(57) ABSTRACT

An integrated security system for automobiles has an activator mounted on the automobile. The activator is interfaced with a geographical locator component based on RADAR, GPS, LORAN or other satellite communications systems to establish the location of the automobile. The system includes a control unit having a computer with a CPU and memory to receive and store the geographical coordinates of the established location. A communications component of the system sends a signal to proper authorities when the stored geographical coordinates change.

### FIELD OF THE INVENTION

This invention relates to the field of automobile tracking, monitoring and reporting to provide a warning or alert when an automobile is taken from a geographical position.

### BACKGROUND OF THE INVENTION

The theft of automobiles is at an all time high. The public has become acutely aware of the large number of automobile thefts which occur each year. A large number of automobile thefts are the result of the increasing demand for replacement parts and the high cost of these parts. The stolen automobile is usually taken to a location where it is disassembled and the parts sent to different locations. The people who steal automobiles for this purpose are “professionals” who know how to bypass most security systems.

Automobile thefts are also the result of people who on the spur of the moment want to go for a “joy ride”. They look for automobiles which are relatively easy to steal. Any type of visible security system will usually deter this type of thief. After they are finished with the automobile they usually abandon it. In many instances the automobiles sustain substantial damage before they are abandoned.

A popular security system is LOJACK. This system is operated by the police or other authorities. Once an owner is aware that their automobile has been stolen they contact the proper authorities who activate the LOJACK tracking device. The police are then notified and can track that specific automobile. In many instances a substantial period of time can pass between the theft of the automobile and the owner becoming aware of the theft and notifying the proper authorities. Further, special tracking equipment is necessary for use in locating a stolen automobile.

What is needed is a security system to monitor such automobiles and alert authorities to the possibility of theft of the automobiles based on an alert initiated by the automobile upon unauthorized displacement from an authorized location.

The system of this invention meets this need by providing a security system for monitoring automobiles referenced to pre-selected geographical coordinates and providing a communication to proper authorities when they are moved from a pre-selected area.

### DESCRIPTION OF THE PRIOR ART

U.S. Pat. No. 6,405,126, issued to Palomo et al., teach a system for providing an in-vehicle route display based on a preselected intended destination for a conveyance.

U.S. Pat. No. 6,587,790, issued to the instant inventor is directed to an anti-terrorist security system for vehicles which is mounted on the vehicle and is interfaced with a geographical locator component based on RADAR, GPS, LORAN or other satellite communications systems to establish the location of the vehicle. A signal is sent to the proper authorities when the vehicle is moved from its authorized location or deviates from its authorized pre-selected path.

U.S. Pat. No. 6,092,000, issued to Batteman, is directed toward substituting ground based recording and storage of in-flight data for the “black boxes” carried by commercial airlines. The system includes an alert signal generating phase activated when the operational data is outside normal limits. The system uses GPS (Global Positioning System) or other locating devices for geographical location of the aircraft. The communications may be satellite, telemetry or cellular systems. The in-flight data is transmitted to a ground based receiver and storage facility.

U.S. Pat. No. 5,933,098, issued to Haxton, discloses an aircraft security system using an aircraft mounted sending unit that sends a timed signal to a central computer once the system is armed. A central computer monitors the various aircraft at a facility. Appropriate alarms are generated, if the signal is not received according to schedule. The system may also include intrusion alarms on the aircraft to indicate tampering. A tracking function uses GPS data to locate an aircraft and transmit the location to the central computer when the aircraft is within the bounds of the network.

U.S. Pat. No. 5,918,183, issued to Janket et al., discloses a mobile transceiver for broadcasting and receiving a radio signal in the cellular telephone band coupled with a GPS for generating a geographical fix. The device is concealed on a vehicle and can signal the police with a fix. The system is activated by an engine start, auto alarm or abnotmal engine start.

U.S. Pat. No. 5,796,178, issued to Onuma, discloses a vehicle mounted system that memorizes or stores the position of engine stop and compares that position with position of attempted engine start. The system blocks engine start if the positions do not match within a predetermined range.

U.S. Pat. No. 5,751,246, issued to Hertel, teaches a system for establishing an electronic geographic perimeter for items equipped with a mobile GPS unit. The permitted geographic perimeter must be loaded into the database by keyboard or other conventional methods. The GPS unit continuously sends a signal to the control unit The control unit sends an alarm when the GPS unit crosses the perimeter boundary. The system can also be used to locate particular items within the perimeter boundary.

What is needed is a system that electronically establishes a geographical position of an automobile in its last authorized position and automatically notifies the proper authorities upon the unauthorized movement of that conveyance.

### SUMMARY OF THE INVENTION

A security system for automobiles wherein an activator is mounted on the automobile. The activator is interfaced with a geographical locator component based on RADAR, GPS, LORAN or other satellite communications systems to establish the location of the automobile. The system includes a control unit having a computer with a CPU and memory to receive and store the geographical coordinates of the established location. A communications component of the system sends a signal to proper authorities when the stored geographical coordinated change.

Accordingly, it is a primary objective of the instant invention to teach an integrated electronic system which generates a signal including the geographical coordinates of an automobile as a reference location and generates an alert signal when the automobile moves from the reference location.

It is a further objective of the instant invention to teach an integrated electronic system that has multiple modes to provide for authorized movement of an automobile without generating an alert.

It is another objective of the instant invention to teach an integrated electronic system to provide geographical coordinates, speed, direction, and elevation during authorized or non-authorized movement upon being electronically interrogated. This data may be superposed on a map.

It is a further objective of the instant invention to teach that the integrated system continues to signal the geographical location coordinates after generating the alert.

It is yet another objective of the instant invention to teach integrating this system into existing systems of suitably equipped automobiles.

Other objects and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a representation of the integrated security system of this invention;

FIG. 2 is a diagram of the hardware modules of this invention;

FIG. 3 is a block diagram of one logic circuit of this invention;

FIG. 4 is a block diagram of another logic of this invention; and

FIG. 5 is a block diagram of the modes of the system of this invention.

### DETAILED DESCRIPTION OF THE INVENTION

GPS is an acronym for a conventional global positioning system based on triangulation between multiple satellites to locate a mobile unit anywhere in the world. GPS will replace most other ground based navigation systems, such as LORAN which is a system of long range radio stations and short range, VOR, aviation net. Initially, the GPS units were being placed in airplanes, boats and road vehicles but the new uses of the system continue to expand, such as inventory control and marketing.

The security system 10 of this invention makes use of GPS as a central component of an integrated system. But for purposes of security, the mobile units which must be mounted on an automobile in such a manner that access to the mobile unit is extremely difficult. The mounting should include concealment, where possible, and re-enforcement. These considerations include the placement of the GPS and communication antennas, as well. The security system 10 may include the use of a switch or entry of data, including a PIN (personal identification number) if desired, into the CPU for activation. The activation could be automatic based upon no movement for a certain time period. The overall object of the installation is to prevent discovery of the system and prevent injury to authorized personnel in any attempt to deactivate the system.

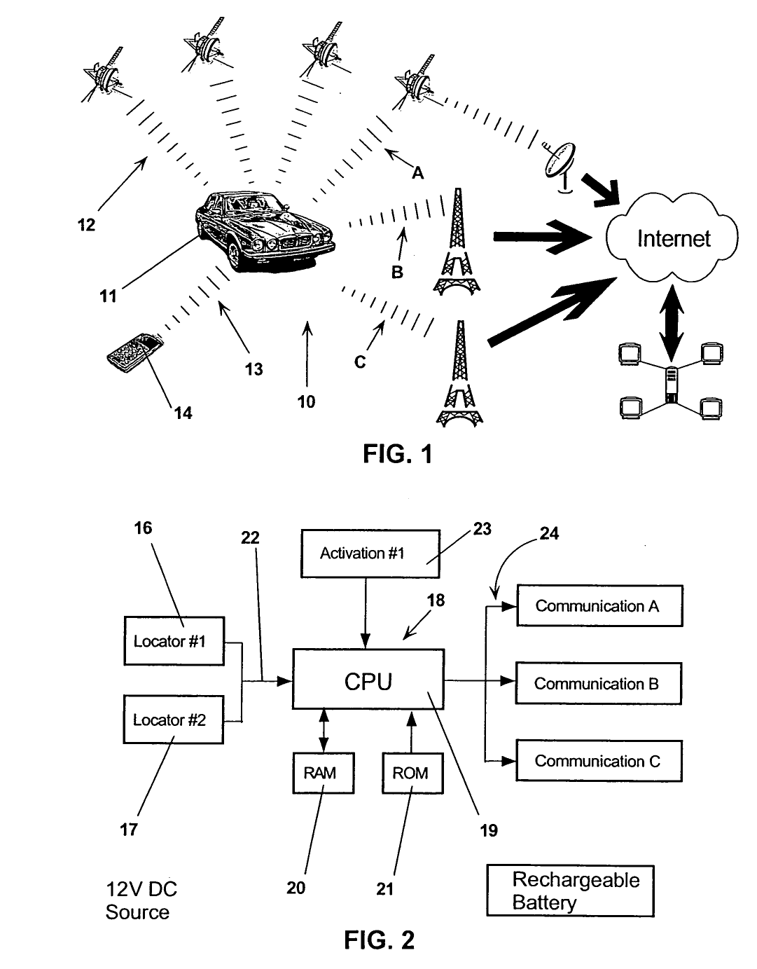

FIG. 1 illustrates the integrated system 10 with an automobile 11. The automobile is equipped with a GPS component 12, depicted by the multiple satellites, with an on-board control unit and a communications component. The activator 13 is shown as a conventional remote 14, like a garage door opener or TV channel changer, which sets or clears a command in the control unit. Once the activator arms the security system, the location of the automobile is an authorized location placed in the memory of the computer. Any subsequent movement of the automobile from the authorized location will be detected by the GPS 12. The control unit activates the communications component to send an alert signal. As shown in FIG. 1, the alert signal may be any one of or all those illustrated, including a satellite link A, a cellular phone link B and/or 2-way pager C. Each of the communications servers can connect to the internet to provide PC based information.

The hardware components are conventional. The system can be powered by a 12 volt DC electrical harness. The electric power may be batteries or any other source mounted on the automobile or connected to the automobile. As shown in FIG. 2, two locator units 16 and 17 are illustrated which may operate in different electronic positioning systems, such as GPS or LORAN. Each of these locator units may be mounted on a different automobile or both may be the mounted on the same automobile. The security system may also use only a single positioning system. The locator units include, at least, an antenna and a receiver (not shown). The locator units are connected to a control unit computer 18 having a CPU 19 with a RAM 20 and a ROM 21. The connection 22 may be hard wired or electronically connected to a remote computer.

The activator 13 which may be a switch or a data entry device such as remote 14. The switch may take the form of a toggle switch or a multiple position switch, or a key lock. The data entry device may have a key pad such as a Palm Pilot. The activator could be activated and deactivated by a telephone or computer as shown on the communications side of FIG. 1. Once the system is activated and in the ARMED mode, the GPS receiver is ON and continually receives GPS updates. The updates may be spaced periodically to conserve electrical power. In these cases, the computer in the control unit 18 stores the GPS data until the satellites are reacquired by the GPS.

When the activator is in the ARMED mode and the STAY mode is selected, the computer stores the geographical coordinates produced by the GPS. These coordinates are considered an authorized location. If a GPS update gives different geographical coordinates from those saved, while in the STAY mode, the control unit sends an ALERT message by the communications component 24. As shown in FIGS. 1 and 2, the ALERT message may be sent by any one or all three A, B, and C communication systems. Obviously, the system may be equipped with only one of the communications links. The recipients of the ALERT message can be anyone or any office placed in the address list of the communications component, for example owners, operators, private security companies, dispatchers, or guards are among those who can be notified.

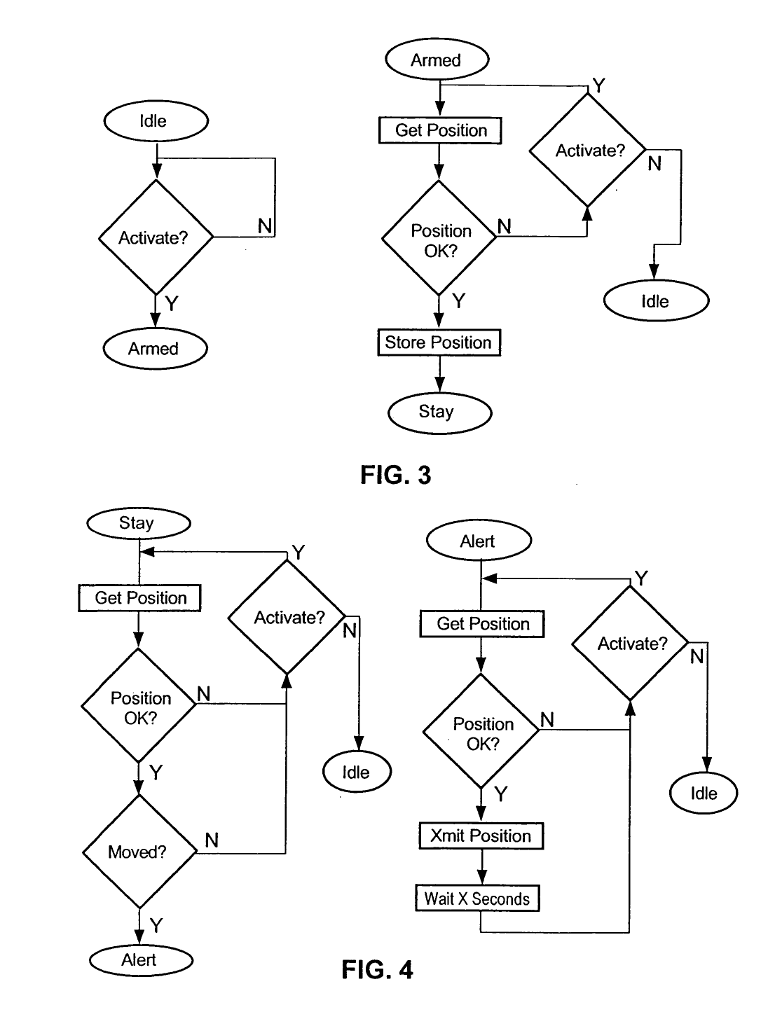

FIG. 3 illustrates the internal logic circuits of the security system with the activation being an either/or option the ARMED mode and the IDLE mode. Once the ARMED mode is selected by the activator, the system may return to IDLE when a good position is acquired by the GPS. This position's coordinates are the same as stored when STAY command is entered in the system.

FIG. 4 shows the logic steps during the STAY phase of operation. The system may be shut down or remain in STAY mode. In STAY mode, the GPS continually gets positions and compares them to stored positions, in FIG. 3, if the position is the same or within permitted parameters, the position is OK. If the location is different or outside limits, it has moved. The control unit issues an ALERT through the communications component.

Once the ALERT message is issued, the system gets positions continuously or periodically. New ALERTS are issued with new positions on a schedule.

Also, during the period when the STAY mode is selected but no ALERT has been issued, the system may be interrogated by any of the communications links shown in FIG. 1. Upon interrogation the system will report its current coordinates and/or speed, direction, elevation. This information may be imposed an a map of any derivation. This is useful when a travel corridor is given as permissible coordinates but the exact location within the perimeter is not immediately known.

Further, in IDLE mode, any of the communications links may be used to interrogate the system to change to the ARMED mode, either on command, randomly or timed sequence. If no response is forthcoming a physical check should be implemented since a loss of electrical power or tampering is indicated.

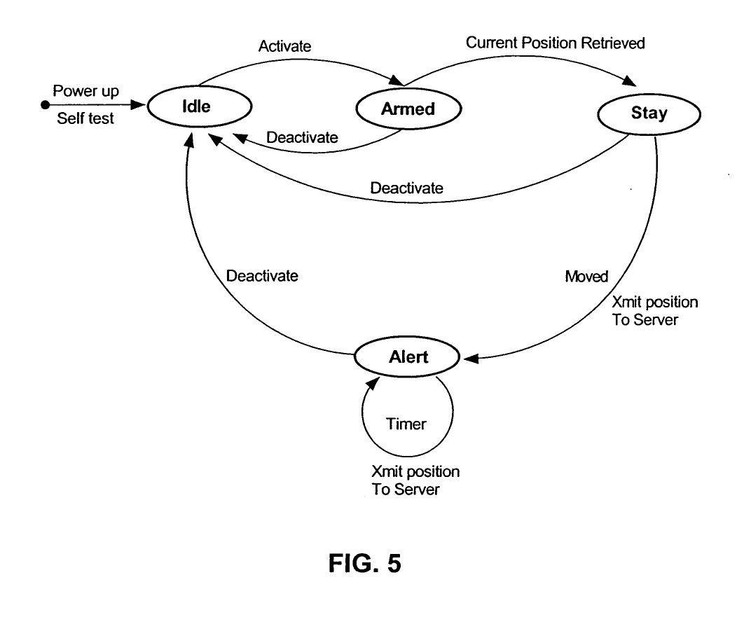

The system modes are illustrated in FIG. 5. There is a power up and self test mode upon initiation of the system. A powered up and ARMED mode may be selected. The STAY mode stores the current position. The ALERT mode is transmitting to selected addresses upon movement of the conveyance from STAY position. The ALERT continues to transmit position reports until deactivated.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A security system for establishing and monitoring the location of an automobile and reporting the movement of the automobile, the system comprising an activator component having multi-modes adapted to be mounted on the automobile and connected to a control unit, said activator producing a real time signal to said control unit, said control unit including a computer having a CPU with a memory and a geographical locator component for producing geographical coordinates of said real time signal of said activator component, said activator signaling said computer to read and store said geographical coordinates of said activator when said activator STAY mode is selected, said computer comparing said geographical coordinates of said real time signal and said geographical coordinates of said STAY mode, said control unit connected to a communications component for automatically sending an alert when said real time signal of said activator is displaced from said stored STAY geographical coordinates.

2. A security system of claim 1 further comprising said activator being a wireless unit with a multi-position switch designating each of said multi-modes.

3. A security system of claim 2 further comprising said activator producing said real time signal periodically.

4. A security system of claim 2 further comprising said control unit interrogating said activator to produce said real time signal.

5. A security system of claim 2 further comprising a discrete electrical power source connected to said activator.

6. A security system of claim 5 further comprising as electrical connection on said activator adapted to connect to the electrical system of an automobile.

7. A security system of claim 2 further comprising an electrical connection on said activator adapted to connect to the electrical system of an automobile.

8. A security system of claim 1 further comprising said communications component including a connection to a wireless net and said alert is aural, visual or image enhancement.

9. A security system of claim 8 further comprising said communications component including a connection to commercial telephony systems and said aural alert is a pre-recorded message.

10. A security system of claim 1 further comprising said activator, said control unit and said communications component being self contained and adapted to be mounted on an automobile.

11. A security system of claim 1 further comprising said activator and said geographical locator component adapted to be mounted on an automobile and said control unit and said communications component remotely located.

12. A security system of claim 1 further comprising said activator having a IDLE mode in which said activator produces no real time signal.

13. A security system of claim 1 further comprising said activator having a IDLE mode in which said communications component sends no alert.

14. A security system of claim 1 further comprising said system having a means for receiving an interrogation through said communications component to said geographical locator, said geographical locator giving current coordinates in response to said interrogation.

15. A security system for automobiles equipped with an electrical system, radios and GPS for establishing, monitoring, and reporting the location thereof comprising an activator adapted to be interfaced with said GPS, a control unit including a computer connected to said activator and a communications component adapted to be interfaced with said radios, said control unit adapted to be connected to said GPS and said electrical system, said activator having a multiple position switch designating multi-modes, said multi-modes including a STAY mode in which said control unit supplies electrical power to said GPS and records said GPS generated geographical coordinates of said activator, said control unit interrogating said GPS periodically in real time and comparing said real time GPS generated geographical coordinates with the recorded GPS generated geographical coordinates, said control unit activating said communications component to send an alert by radio when said real time coordinates are different from said recorded coordinates.

16. A security system of claim 15 further comprising said STAY mode including a plurality of preselected geographical coordinates of a travel corridor are entered in said GPS and said control unit, said control unit interrogating said GPS periodically in real time and comparing said real time GPS generated coordinates with said plurality of preselected geographical coordinates, said control unit activating said communications component to send an alert by radio when said real time coordinates are different from said plurality of said preselected coordinates.

17. A method of deterring unauthorized use of an automobile comprising the steps of:
a) providing an electronic activator including a GPS, a transmitter and a multi-mode switch with at least IDLE, ARMED, and STAY positions,
b) mounting said activator on said automobile,
c) providing a control unit including a computer with a CPU and memory connected to said activator, said control unit having a communications component for sending an alarm,
d) selecting STAY position when said conveyance is positioned in a desired location,
e) sending a real time signal from said activator to said control unit with geographical coordinates of said desired location,
f) reading and storing said geographical coordinates by said control unit,
g) sending subsequent real time signals with the geographical coordinates of the real time location,
h) comparing said stored geographical coordinates with said subsequent geographical coordinates,
i) activating said communications component to alert authorities when said stored geographical coordinates are not the same as subsequent geographical coordinates, and
j) continuing to update subsequent geographical coordinates.
